(19) United States
(12) Patent Application Publication
(10) Pub. No.: US 2022/0402233 A1
(43) Pub. Date: Dec. 22, 2022

(54) PROTECTION OF SURFACE TEXTURES FROM ABRASION

(71) Applicant: Sharklet Technologies, Inc., Aurora, CO (US)

(72) Inventors: Megan Lee Carrick, Denver, CO (US); Kevin Lee Ballard, Aurora, CO (US); Ryan Eugene Stoneberg, Aurora, CO (US); Christopher Joseph Jones, Centennial, CO (US)

(21) Appl. No.: 17/776,317

(22) PCT Filed: Nov. 12, 2020
(86) PCT No.: PCT/US2020/060113

§ 371 Date: May 12, 2022

Related U.S. Application Data
(60) Provisional application No. 62/934,814, filed on Nov. 13, 2019.

(51) Int. Cl. B32B 3/02; B33Y 70/00; B33Y 80/00; B33Y 10/00

(52) U.S. Cl. CPC B32B 3/02; B33Y 70/00; B33Y 80/00; B33Y 10/00

(57) ABSTRACT

Disclosed herein is an article that protects surface textures from abrasion as a result of regular wear and tear. The article comprises a substrate comprising a first texture and a second texture, where the second texture is in a protective relationship with the first texture and protects elements of the first texture from being abraded by an external surface. The first texture comprises a first plurality of features having a first height measured from a base of the substrate and the second texture comprises a second plurality of features having a second height measured from the base of the substrate. The height of the second texture is greater than the height of the first texture. The second texture comprises a plurality of non-uniform cells; and wherein the first texture is disposed on a surface of the second texture.

### CROSS REFERENCE TO RELATED APPLICATIONS

This application claims the benefit of U.S. Application No. 62/934,814 filed on Nov. 13, 2019 which is incorporated herein by reference in its entirety.

### BACKGROUND

The present invention relates to a method to protect surface textures from abrasion as a result of regular wear and tear. It also relates to articles, where the surface textures on the articles are protected from abrasion. More specifically, the present invention relates to controlling the dimension, patterning, and distribution of the surface textures in order to protect them from abrasion.

Biofouling is the unwanted accumulation of organic and inorganic matter of biological origin on surfaces. For example, in the marine environment biofouling is the result of marine organisms settling, attaching, and growing on submerged marine surfaces. The biofouling process is initiated within minutes of a surface being submerged in a marine environment by the absorption of dissolved organic materials which result in the formation of a conditioning film. Once the conditioning film is deposited, microbes (e.g., unicellular algae, bacteria, or fungi) colonize the surface within hours of submersion. The resulting biofilm produced from the colonization by the microbes is referred to as biofilm microfouling, or slime and can reach thicknesses on the order of 500 nm (micrometer).

Any substrate in regular contact with water is likely to become fouled. No surface has been found that is completely resistant to fouling. Due to the vast variety of organisms that form biofilms, the development of a single surface coating with fixed surface properties for the prevention biofilm formation for all relevant organisms is a difficult if not impossible task. Alternatively, surfaces that have patterns and other forms of texturing (hereinafter “texturing”) can be advantageously used to minimize the adhesion of living organisms and other forms of non-living matter (e.g., ice, dust, dirt, and the like) to the surface. Texturing can have dimensions that are selected to specifically prevent the adhesion of specific living organisms or non-living matter on the surface.

In order to avoid biofouling, once the surface textures are formed on any given surface, it is also essential to preserve these surface textures by minimizing the effects caused due to normal wear and tear on the surface. Therefore, it is desirable to have methods and/or products that can maintain the dimensions of the surface textures.

### SUMMARY

Disclosed herein is an article comprising a substrate that comprises a first texture and a second texture, where the second texture is in a protective relationship with the first texture and protects elements of the first texture from being abraded by an external surface. The first texture comprises a first plurality of features having a first height measured from a base of the substrate and the second texture comprises a second plurality of features having a second height measured from the base of the substrate. The height of the second texture is greater than the height of the first texture. The second texture comprises a plurality of non-uniform cells. The first texture is disposed on a surface of the second texture.

Disclosed herein too is a method comprising disposing on a substrate a second texture and disposing on the second texture a first texture; where the second texture is in a protective relationship with the first texture and protects elements of the first texture from being abraded by an external surface. The first texture comprises a first plurality of features having a first height measured from a base of the substrate and the second texture comprises a second plurality of features having a second height measured from the base of the substrate, where the second height is greater than the first height; and wherein the second texture comprises a plurality of non-uniform cells.

### BRIEF DESCRIPTION OF THE DRAWINGS

A fuller understanding of the present invention and the features and benefits thereof will be obtained upon review of the following detailed description together with the accompanying drawings, in which:

FIG. 1 depicts a side view of an article with a textured surface;

FIG. 2(A) depicts a profile of the substrate surface before disposing a texture on it;

FIG. 2(B) depicts a profile of the substrate surface after disposing the second texture on it;

FIG. 2(C) depicts a profile of the substrate surface after disposing the first texture on it;

FIG. 3 (A) depicts one exemplary texture;

FIG. 3 (B) depicts one exemplary texture;

FIG. 3 (C) depicts one exemplary texture;

FIG. 3 (D) depicts one exemplary texture;

FIG. 3 (E) depicts one exemplary texture;

FIG. 3 (F) depicts one exemplary texture;

FIG. 4 depicts the macro-texture on one inventive samples; and

FIG. 5 depicts a study of the microbiology adhesion trend for the exemplary inventive textures under two different conditions and compares it with the control.

### DETAILED DESCRIPTION

It is to be noted that as used herein, the terms “first,” “second,” and the like do not denote any order or importance, but rather are used to distinguish one element from another, and the terms “the”, “a” and “an” do not denote a limitation of quantity, but rather denote the presence of at least one of the referenced items. Furthermore, all ranges disclosed herein are inclusive of the endpoints and independently combinable.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Disclosed herein is an article that comprises a substrate which has a plurality of textures disposed on its surface. In an embodiment, the substrate comprises a second texture upon which is disposed a first texture. The individual features of the second texture are larger than the individual features of the first texture and therefore provide substantial protection to the feature of the first texture. The second texture is in a protective relationship with the first texture and prevents the first texture from being abraded or damaged during use. In an embodiment, a first texture is disposed on a surface of a second texture, where the second texture is operative to protect elements of the first texture from external abrasive forces.

The substrate can have a cross-sectional geometry that may be circular, triangular, rectangular, square, polygonal, or a combination thereof. Examples of substrates can be chop-sticks, spoons, forks, knives, tubes, surfaces of sea-going vessels, and the like. The surfaces of the substrate may be planar or curved. The substrate may comprise a metal, a ceramic, a polymer, or a combination thereof. Metallic substrates can include transition metal substrates, alkaline earth metal substrates, alkali substrates, or a combination thereof. Suitable metals are aluminum, iron, copper, titanium, zirconium, gold, silver, platinum, zinc, cobalt, nickel, tantalum, chromium, manganese, magnesium, vanadium, or a combination thereof. Alloys of metals may also be used in the substrate. Common alloys include steel, carbon steel, bronze, brass, or the like. Alloys of metals with ceramics may also be used in the substrate.

In an embodiment, the substrate may comprise a ceramic. Ceramics may include oxides, carbides, oxycarbides, nitrides, oxynitrides, borides, borocarbides, boronitrides, silicides, iodides, bromides, sulfides, selenides, tellurides, fluorides or borosilicides of metals. Common ceramics include silicon dioxide, aluminum oxide, titanium dioxide, zirconium dioxide, indium tin oxide, antimony tin oxide, cerium oxide, cadmium-oxide, titanium nitride, silicon nitride, aluminum nitride, titanium carbide, silicon carbide, titanium niobium carbide, stoichiometric silicon boride compounds (SiBₙ, where n=14, 15, 40, and so on) (e.g., silicon triboride, SiB₃, silicon tetraboride, SiB₄, silicon hexaboride, SiB₆, or the like), or the like, or a combination thereof.

In yet another embodiment, the substrate comprises an organic polymer. Organic polymers used in the spaced features and/or the surface can be may be selected from a wide variety of thermoplastic polymers, blend of thermoplastic polymers, thermosetting polymers, or blends of thermoplastic polymers with thermosetting polymers. The organic polymer may also be a blend of polymers, copolymers, terpolymers, or combinations comprising at least one of the foregoing organic polymers. The organic polymer can also be an oligomer, a homopolymer, a copolymer, a block copolymer, an alternating block copolymer, a random polymer, a random copolymer, a random block copolymer, a graft copolymer, a star block copolymer, a dendrimer, a polyelectrolyte (polymers that have some repeat groups that contain electrolytes), a polyampholyte (a polyelectrolyte having both cationic and anionic repeat groups), an ionomer, or the like, or a combination comprising at last one of the foregoing organic polymers. The organic polymers have number average molecular weights greater than 10,000 grams per mole, preferably greater than 20,000 g/mole and more preferably greater than 50,000 g/mole.

Exemplary organic polymers include Examples of thermoplastic polymers that can be used in the polymeric material include polyacetals, poly acrylics, polycarbonates, polyalkyds, polystyrenes, polyolefins, polyesters, polyamides, polyaramides, polyamideimides, polyarylates, polyurethanes, epoxies, phenolics, silicones, polyarylsulfones, polyethersulfones, polyphenylene sulfides, polysulfones, polyimides, polyetherimides, polytetrafluoroethylenes, polyetherketones, polyether ether ketones, polyether ketone ketones, polybenzoxazoles, polyoxadiazoles, polybenzothiazinophenothiazines, polybenzothiazoles, polypyrazinoquinoxalines, polypyromellitimides, polyguinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polycarboranes, poly oxabicyclononanes, polydibenzofurans, polyphthalides, polyacetals, poly anhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, poly sulfonamides, polyureas, polyphosphazenes, polysilazanes, polypropylenes, polyethylenes, polyethylene terephthalates, polyvinylidene fluorides, polysiloxanes, or the like, or a combination comprising at least one of the foregoing thermoplastic polymers.

Examples of polyelectrolytes are polystyrene sulfonic acid, polyacrylic acid, pectin, carrageenan, alginates, carboxymethylcellulose, polyvinylpyrrolidone, or the like, or a combination comprising at least one of the foregoing polyelectrolytes.

Examples of thermosetting polymers suitable for use as hosts in emissive layer include epoxy polymers, unsaturated polyester polymers, polyimide polymers, bismaleimide polymers, bismaleimide triazine polymers, cyanate ester polymers, vinyl polymers, benzoxazine polymers, benzocyclobutene polymers, acrylics, alkyds, phenol-formaldehyde polymers, novolacs, resoles, melamine-formaldehyde polymers, urea-formaldehyde polymers, hydroxymethylfurans, isocyanates, diallyl phthalate, triallyl cyanurate, triallyl isocyanurate, unsaturated polyesterimides, or the like, or a combination comprising at least one of the foregoing thermosetting polymers.

The first texture and the second texture may be disposed on the substrate. The first texture has individual features that are smaller than the individual features of the second texture. The spacing between the individual features of the first texture are smaller than the spacing between the individual features of the second texture. The first texture is disposed on the surface of the second texture, which is itself disposed on the original surface of the substrate. In other words, the original surface of the substrate is first deformed by the disposal of the second texture. The disposal of the second texture on the substrate creates a first surface that is different in geometry from the original surface. In an embodiment, the first surface has a surface area that is larger than in area than that of the original surface. In an embodiment, the second texture protrudes inwards into the original substrate surface. In another embodiment, the second texture protrudes inwards and outwards from the original substrate surface.

The first texture is then disposed on the second texture to create a second surface. The second surface modifies the first surface and increases the surface area of the second surface to be greater than that of the first surface. In an embodiment, the first texture can protrude outwards from the first surface. In another embodiment, the first texture can protrude inwards from the first surface. In yet another embodiment, the first texture can protrude inwards and outwards from the first surface.

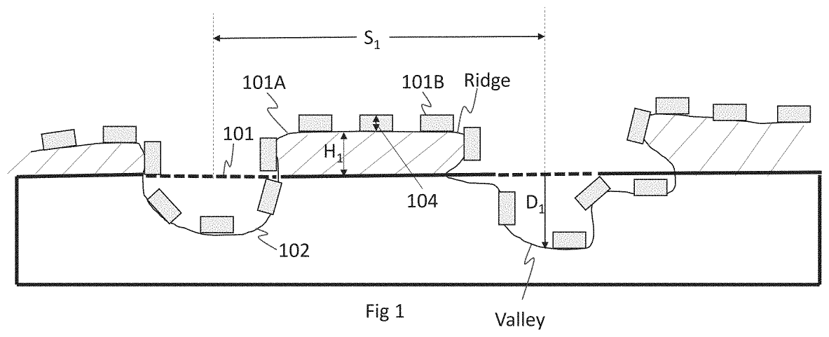

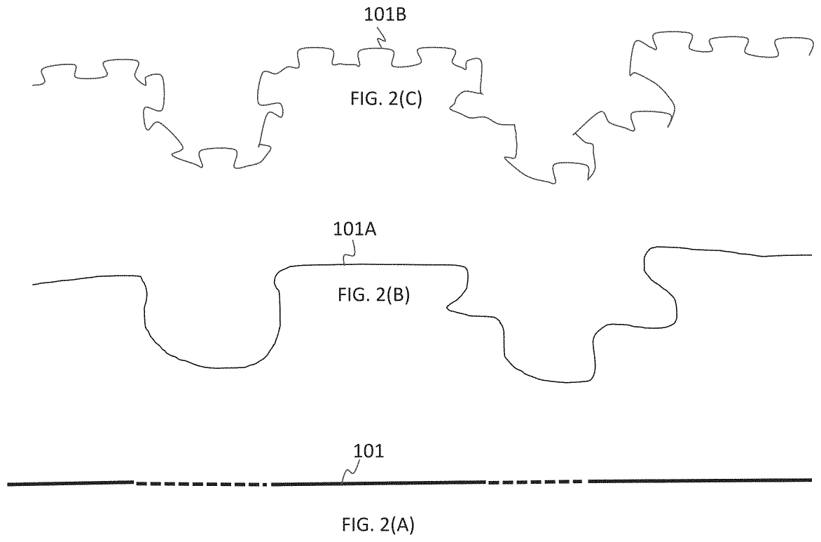

FIG. 1 is a schematic of an exemplary depiction of the substrate 100 modified by the second texture 102 and the first texture 104. The original surface 101 is modified by disposing the second texture 102 on it to create a new surface 101A. The second texture 102 is then modified by disposing a first texture 104 on it. This creates a new surface 101B. FIGS. 2(A), 2(B) and 2(C) depict the three profiles of the substrate surface. FIG. 2(A) depicts the substrate surface 101 before the second texture 102 is disposed on it to create the surface 101(A), which is depicted in the FIG. 2(B). The FIG. 2(C) depicts the surface after the first texture 104 is disposed on the second texture to create the new surface 101(B). As may be seen in the FIGS. 2(A), 2(B) and 2(C), the surface area of the surfaces increase with each texturing operation. A third texture may be disposed on the second texture if desired. In another embodiment, a third texture may be disposed on the first texture only to create a hierarchical structure. In short, the substrate may have a plurality of textures disposed on the surface, where each successive texture increases the surface area of the textured surface.

From the FIG. 1 it may be seen that the second texture 102 protrudes below the original substrate surface 101 as well as above the original substrate surface 101. In the FIG. 1, the first texture 104 is then disposed on the second texture 102 and protrudes outwards from the first surface 101(A) to create the second surface 101(B). The periodicity and size of the second features 102 are larger than the periodicity and size of the first features 104.

The second features 102 irregular in shape and size. The irregularity in the second feature shape and size prevents repeated abrasion in a particular portion or region when two or more substrates having the textured surfaces are repeatedly brought into contact with each other, such as, for example, in a dishwasher during washing. The second features 102 are irregular in shape, size and spacing and have a distribution in shape, size and spacing. The shape of the second features are irregular.

There is a distribution in the heights H₁ of the protrusions above the original surface and there is also a distributions in the depths D₁ of the protrusions below the original surface. The distribution may be Gaussian, Lorentzian, or the like. The average heights H₁ and average depths D₁ can vary from 5 to 100 micrometers, preferably 10 to 80 micrometers, and more preferably 15 to 75 micrometers. The average spacing S₁ between the second features 102 can vary from 20 micrometers to 500 micrometers, preferably 30 to 480 micrometers, and more preferably 50 to 400 micrometers.

In an embodiment, it is desirable to maximize the surface area of the second features that are present in the protrusions into the surface (the valleys) versus the surface area of the second features that are present on the protrusions outwards (the ridges) from the surface (See FIG. 1). In an embodiment, the ratio of surface area present in the valley to the surface area present on a ridge is greater than 2:1, preferably greater than 4:1, preferably greater than 6:1 and more preferably greater than 10:1.

In an embodiment, the second features are such that the protrusions into the surface (the valleys) are separated from each other by the protrusions outwards from the surface (the ridges). In other words, the valleys are separated from one another because they are separated from each other by the ridges. In another embodiment, the valleys and the ridges are co-continuous, i.e., the valleys are not separated from each other by ridges. The second pattern therefore comprises (or creates) a number of non-uniform cells that have a distribution of heights and widths and that can be separated from each other (by the ridges) or alternatively, that can connect with each other while being bounded by the ridges. The ridges can be continuous. The valleys and the ridges have a non-Euclidean geometry.

The first features 104 are smaller than the second features 102 and are disposed on the outward and inward protrusions created by the second features 102. In other words, the first features are disposed on the first surface 101(A) to create the second surface 101(B). In an embodiment, the first features are disposed on the entire first surface 101(A) to create the second surface 101(B). In another embodiment, the first features are disposed on at least 50%, preferably at least 70%, and more preferably at least 90% of the first surface 101(A) to create the second surface 101(B).

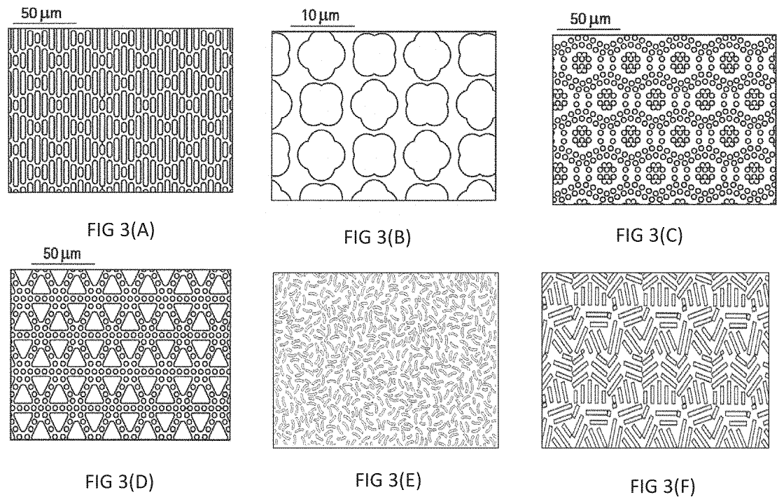

The first features 104 are grouped together to form a pattern. The pattern forms a repeat unit and is replicated across the surface 101(A) to produce the surface 101(B). In other words, patterns are grouped together to form the texture that is disposed across the surface 101(A) to produce the surface 101(B). FIG. 3(A) through 3(F) depict various patterns that can be disposed on the surface 101(A).

In an embodiment, the plurality of first features 104 are arranged in a plurality of groupings and the groupings are arranged with respect to one another to define a tortuous pathway when viewed in a first direction. When viewed in a second direction, the groupings of first features 104 are arranged to define a linear pathway. In an embodiment, at least one first feature is shared between neighboring groupings. In one embodiment, each grouping can have an odd number of first features, while in another embodiment, each grouping can have an even number of first features. In an embodiment, each first feature in a grouping is different from at least one of its neighboring first features. In another embodiment, each first feature in a grouping is different from each of its neighboring first features. The difference may be in the size or shape of the first features.

In one embodiment, when viewed in a second direction, the pathway between the first features may be non-linear and non-sinusoidal. In other words, the pathway can be non-linear and aperiodic. In another embodiment, the pathway between the first features may be linear but of a varying thickness. The plurality of spaced first features may be projected outwards from the surface 101(A) or projected into the surface 101(A). In one embodiment, the plurality of spaced first features may have the same chemical composition as the surface. In another embodiment, the plurality of spaced first features may have a different chemical composition from the surface.

In one embodiment, the plurality of spaced first features 104 may be part of a coating that is applied to the surface 101(A) created by the second features 102. The coating may be a metal coating, a ceramic coating, or a polymeric coating. The metals, ceramics and polymers listed above may be used in the coatings.

In one embodiment, the first features do not have a distribution in spacings between neighboring first features (See FIGS. 3(A) and 3(B)). In another embodiment, the first features have a distribution in spacings between neighboring first features (See FIGS. 3(E) and 3(F)). In an embodiment, there is a distribution in the size and shape of the first features.

In an embodiment, the first features have an average width of 10 nanometers to 50 micrometers, preferably 100 nanometers to 20 micrometers, and more preferably 500 nanometers to 10 micrometers.

In an embodiment, the first features have an average spacing of 10 nanometers to 50 micrometers, preferably 100 nanometers to 20 micrometers, and more preferably 500 nanometers to 10 micrometers.

In an embodiment, the average ratio of the heights of the second features 102 to the first features varies from 2.5 to 20, preferably 3 to 15, and more preferably 5 to 10.

As noted above, the groupings of first features are separated from a neighboring groupings of first features by a tortuous pathway. The tortuous pathway may be represented by a periodic function. The periodic functions may be different for each tortuous pathway. In one embodiment, the patterns can be separated from one another by tortuous pathways that can be represented by two or more periodic functions. The periodic functions may comprise a sinusoidal wave. In an exemplary embodiment, the periodic function may comprise two or more sinusoidal waves.

In another embodiment, when a plurality of different tortuous pathways are represented by a plurality of periodic functions respectively, the respective periodic functions may be separated by a fixed phase difference. In yet another embodiment, when a plurality of different tortuous pathways are represented by a plurality of periodic functions respectively, the respective periodic functions may be separated by a variable phase difference.

In one embodiment, the plurality of spaced first features have a substantially planar top surface. In another embodiment, a multi-element plateau layer can be disposed on a portion of the first surface 101(A). In other words, different first features can have different heights when measured from the surface 101(A).

In one embodiment, in one method of manufacturing a textured surface, an article is first manufactured. The article serves as the substrate and is manufactured via injection molding, compression molding, vacuum forming, blow molding, or the like. In an embodiment, the larger second features may be disposed on the surface during the formation of the article. This may be accomplished by using a mold that has a negative image of the texture on its surface. For example, during the molding operation, the larger second features are disposed on the original surface of the substrate to produce the surface 101(A). The substrate with the second features 102 contacted thereon may then be contacted with a second mold to produce a surface 101(B) with the first features 104.

In another embodiment, in another method of manufacturing the article, the second features may be produced by other methods including abrasion, etching, grinding, ablation, or the like. The substrate with the second features disposed thereon are then contacted with a mold that imparts the first features to the substrate.

In yet another embodiment, the second features and the first features may be printed onto the substrate using additive manufacturing.

The invention is exemplified by the following non-limiting example.

### EXAMPLES

It should be understood that the Examples described below are provided for illustrative purposes only and do not in any way define the scope of the invention.

The following experiment is conducted on an article (acrylic coupons) to evaluate wear resistance of the article. The surface is textured using the multiple patterns described in this disclosure, as shown in FIG. 1, where a substrate that comprises a polyacrylic is textured with the second texture followed by the first texture. The samples include a “smooth” sample (which does not have the first texture or the second texture), a sample labelled “microtexture only” that contains only the first texture (which is a microtexture similar to that shown in the FIG. 3(A)) and 5 samples that contained both the second texture (which is a macrotexture) and the first texture (which is the microtexture shown in the FIG. 3(A). While the microtexture on each of the 5 samples was the same, the macrotexture on each of the five samples was different—and these are listed as follows—1055, 11020, 11240 11445 and 11530. These samples are therefore listed as “Micropattern w/1055”, “Micropattern w/11020”, “Micropattern w/11240”, “Micropattern w/11445” and Micropattern w/11530. Details of the second texture are shown in the Table 1 below.

TABLE 1

| | | Nominal | Mean | Mean | |
|---|---|---|---|---|---|
| | | Pattern | number of | area/ | |
| Macro- | | Depth | peaks/ | peak | |
| pattern | Classification | (μm) | image | (μm2) | SEM |
| MT-11020 | Medium Peak | 40 μm | 21.7 | 185907 | 23448 |
| | Count | | | | |
| MT-11530 | High Peak Count | 33 μm | 32 | 113795 | 14056 |
| MT-11240 | Stipple Pattern | 35 μm | 19 | 171356 | 29642 |
| MT-11445 | Brushed Metal | 40 μm | 20.7 | 195708 | 29736 |
| | Pattern | | | | |
| MT-1055 | Low Peak Count | 40 μm | 16.3 | 226434 | 39574 |

A rolling method using the Sutherland Rub Tester is implemented to replicate the wear that the acrylic coupon would endure due to an external abrasive force like washing. This involved making a small cart with polyethylene rollers that would roll over the acrylic coupons and create a similar wear pattern to rubbing the acrylic coupons together when washing multiple times. The polyacrylic coupon is placed in a fixture on the Sutherland Rub Tester. The rolling cart is set on top of the coupon and a four-pound weight is attached to the arm of the rub tester. Each coupon is rubbed 3650 times, equivalent to rolling the acrylic coupons on the pattern 10 times per wash multiplied by 365 days a year. Therefore, the polyacrylic coupons were worn as if the article/polyacrylic coupons were used once daily for a year.

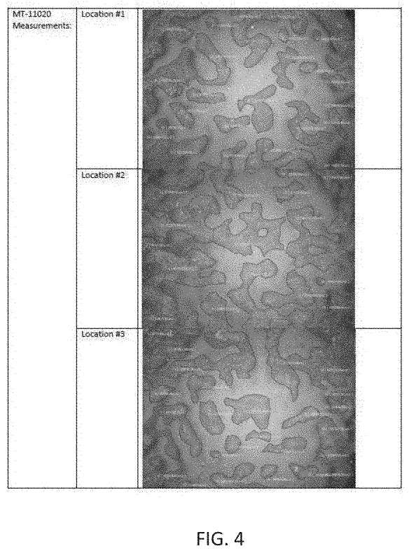

Measurements of the amount of wear on each acrylic coupon is taken using a Keyence VHX-2000 Microscope at 100× magnification. In FIG. 4, the area measurements and amount of wear at three different locations on one sample are shown. Similar measurements were made on other inventive examples at three locations to get an average of the percentage of scratched area to the total area. The following Table 2 shows the amount of wear for the various inventive acrylic coupons.

TABLE 2

| | | Average |
|---|---|---|
| | Percent of | Percent of |
| | Scratched to | Scratched to |
| Pattern: | Total Area | Total Area |
| First Texture | 100* | 100* |
| Only | 100* | |
| | 100* | |
| Inventive | 42.1 | 46.71 |
| Example 1 | 51.2 | |
| (11020) | 46.82 | |
| Inventive | 52.14 | 42.27 |
| Example 2 | 35.18 | |
| (11530) | 39.5 | |
| Inventive | 60.94 | 45.43 |
| Example 3 | 39.19 | |
| (11240) | 36.15 | |
| Inventive | 44 | 46.93 |
| Example 4 | 46.48 | |
| (11445) | 50.32 | |
| Inventive | 47.19 | 42.78 |
| Example 5 | 36.31 | |
| (1055) | 44.83 | |

Table 2 shows the effective wear of the inventive samples. The percentage of unscratched/non-weathered area is the same as the area that is protected from abrasion. It is calculated by measuring the average percentage of area that was scratched compared to the total amount of area. As seen in Table 1, the average percentage of the protected area is between 53% to 57%. The coupon with only the first texture was unable to be measured since the locations that were observed had no identifiable micropattern left after being worn.

All the inventive samples described above were subjected to the touch-transfer protocol STM031 with E. coli CDCP strain to evaluate whether 40% to 50% of the protected first texture is enough to maintain the microbial efficacy of the first texture. In this example, the first texture (Sharklet) is known to prevent touch-transfer of microbes between surfaces. This experiment was designed to determine the efficacy of the second texture in preventing wear of the first texture, and therefore preserving its role in reducing microbial transfer.”

Samples were sonicated for 10 minutes in DI (Deionized) water at room temperature, then rinsed and wiped with DI water to remove any particulate from the manufacturing process. Samples were affixed to a Petri plate with double-sided tape and sterilized by exposure to UV (Ultra violet) light for at least 15 minutes. Samples were inoculated with filter papers soaked in ˜1.0×10⁷ CFU/mL (Colony-forming unit/milliliter) of E. coli as described in STM031. Following inoculation, samples were allowed to dry, and bacteria were recovered and enumerated using RODAC (Replicate Organism Detection and Counting) plates. This method evaluates the touch-transfer of microbes to and from a surface.

The smooth, (first texture) micropattern-only-unworn and (first texture) micropattern-only-worn samples were tested as controls for each group. Bar graphs represent average log CFU recovered and error bars represent the standard error of the mean. Percent reduction of bacterial recovery compared to the average of all smooth samples is indicated above each bar. Significant differences between worn and unworn samples of the same pattern were determined with a two-tailed Student's t-test. (ns—not significant, * p≤0.05, *** p≤0.001, ****p≤0.0001)

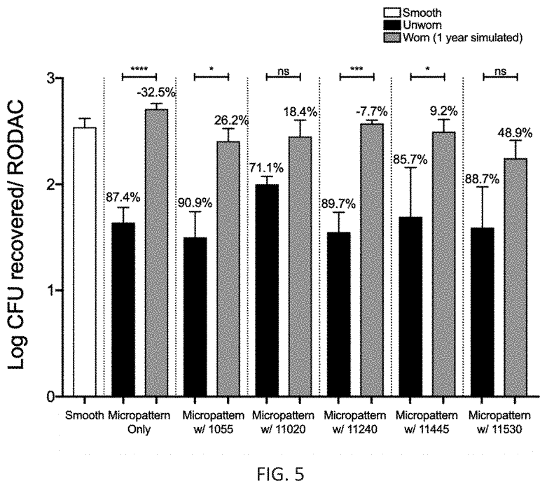

FIG. 5 depicts a study of the microbiology adhesion trend for the exemplary inventive textures under two different conditions and compares it with the control. The FIG. 5 shows that that the sample with the micropattern-only (unworn) reduced the percentage of the E. coli that was able to colonize on the smooth surface by 87.4%. All of the numerical data is compared with regard to the smooth surface. However, the micropattern-only (worn) sample showed an increase in the percentage of E. coli that colonized its surface by 32.5%. This shows that a sample that has only one texture (the first texture) suffers severely from abrasion and this causes an increase in the amount of E. coli that colonizes the surface. Each of the samples that had both the first texture (the microtexture) and the second texture (the macrotexture) showed a decrease in the amount of bacteria (E. coli) that colonized its surfaces before and after undergoing abrasion.

Referring to FIG. 5, it can be seen that the colonization on the various samples having the micropattern (the first texture) with the macropattern (the second texture) is similar to the percent reduction of the micropattern-only, under unworn conditions. Therefore, it can be concluded that texturing a macropattern (the second texture) with a micropattern (the first texture) did not affect the efficacy of the original micropattern.

However, when the worn samples where tested it may be seen that the samples with both textures—the first texture and the second texture had substantially less colonization than the sample that contained the microtexture.

For example, the Micropattern w/1055 sample reduced the amount of colonization by 26.2 percent relative to the smooth untextured surface, while the sample that contained only the microtexture had an increased amount of colonization by 32.5 percent relative to the smooth untextured surface when it was worn. This shows that the use of two textures—a first (micro) texture disposed on a second (macro) texture preserves a portion of the texture when subjected to continuous simulated abrasion for a period of 1 year. The portion of the first texture may range from 25% to 75% based on the total amount of the original amount of the first texture.

1. An article comprising:
a substrate that comprises a first texture and a second texture;
wherein the second texture is in a protective relationship with the first texture and protects elements of the first texture from being abraded by an external surface;
wherein the first texture comprises a first plurality of features having a first height measured from a base of the substrate upon which it is disposed and wherein the second texture comprises a second plurality of features having a second height measured from the base of the substrate;
wherein the second height is greater than the first height;
wherein the second texture comprises a plurality of non-uniform cells; and
wherein the first texture is disposed on a surface of the second texture.

2. The article of claim 1, wherein the second texture protrudes into the base of the substrate.

3. The article of claim 1, wherein the non-uniform cells have a distribution in height and width.

4. The article of claim 1, wherein the non-uniform cells comprise ridges and valleys.

5. The article of claim 4, wherein the ridges are in continuous contact with one another.

6. The article of claim 4, wherein the valleys are separated from one another by the ridges.

7. The article of claim 4, wherein the valleys are in continuous contact with one another.

8. The article of claim 1, wherein the ridges have a non-Euclidean geometry.

9. The article of claim 1, wherein the first texture comprises a first plurality of features each have at least one neighboring feature having a substantially different geometry, and wherein an average spacing between adjacent spaced apart features is about 1 nanometer to about 1 millimeter.

10. The article of claim 1, wherein an average spacing between the first plurality of features is less than the average spacing between the second plurality of features.

11. The article of claim 1, wherein the average spacing between the first plurality of features does not include a spacing distribution, while the average spacing between the second plurality of features involves a distribution of spacings.

12. A method comprising:
disposing on a substrate a second texture; and
disposing on the second texture a first texture; wherein the second texture is in a protective relationship with the first texture and protects elements of the first texture from being abraded by an external surface;
wherein the first texture comprises a first plurality of features having a first height measured from a base of the substrate and wherein the second texture comprises a second plurality of features having a second height measured from the base of the substrate;
wherein the second height is greater than the first height; and
wherein the second texture comprises a plurality of non-uniform cells.
